(19) United States
(12) Patent Application Publication
(10) Pub. No.: US 2015/0062762 A1
(43) Pub. Date: Mar. 5, 2015

(54) SEMICONDUCTOR DEVICE

(71) Applicant: Renesas Electronics Corporation, Kawasaki-shi (JP)

(72) Inventor: Keishi FUJII, Kanagawa (JP)

(73) Assignee: RENESAS ELECTRONICS CORPORATION, Kawasaki-shi (JP)

(21) Appl. No.: 14/474,826

(22) Filed: Sep. 2, 2014

(30) Foreign Application Priority Data
Sep. 3, 2013 (JP) 2013-182567
Apr. 17, 2014 (JP) 2014-085179

(51) Int. Cl. H02H 9/04; H02H 1/00

(52) U.S. Cl. CPC H02H 9/04; H02H 1/0007
USPC 361/56

(57) ABSTRACT

Two resistances having different temperature coefficients are connected in series between a plurality of output transistors which are provided in parallel, and the power supply. A difference between these resistance values of the two resistances changes according to a temperature change. The change of the difference in the resistance value is detected as a change of voltage and a control signal is generated. According to the control signal, a protection transistor operates to connect an input node, and an output node or the both of the input node and the output node to the ground. As a result, in case of the extraordinary generation, the current to be supplied to a rear stage is restrained.

### CROSS REFERENCE

This patent Application claims priorities on convention based on Japanese Patent Application Nos. JP 2013-182567 and JP 2014-085179, disclosures of which are incorporated herein by reference.

### TECHNICAL FIELD

The present invention is related to a semiconductor device, and is used suitably for a semiconductor device which contains a photo-coupler.

### BACKGROUND ART

A drive logic circuit section is sometimes provided at a front-stage of power transistors to generate a drive signal for driving power transistors such as an IGBT (Insulated Gate Bipolar Transistor) and a MOS (Metal Oxide Semiconductor) transistor. As an example of a semiconductor device which contains the drive logic circuit section and an output circuit to amplify the drive signal to output to a load at a rear stage such as the power transistors, a photo-coupler and so on are exemplified.

When a high-speed switching operation is carried out in accompaniment with the amplification of the drive signal, such an output circuit is influenced by noise transferred from a rear stage so that a large current sometimes flows through the power transistor. A transistor of the output circuit as well as the power transistor at the rear stage are degraded or are destroyed due to the transient over-current and the over-heat generated in such a case.

Patent Literature 1 (JP 2007-315836A) discloses that an over-heat detecting circuit which has a simple circuit configuration and in which a deviation of detection temperature can be made small.

However, the over-heat detecting circuit according to Patent Literature 1 has the following problems. That is, two constant current sources need to be provided to steadily supply constant currents to two temperature detecting devices, and great power is required. These temperature detecting devices are built in a semiconductor chip in which a power MOS transistor as a protection object is built, but a temperature difference is sometimes generated in the chip because of the influence of these position relation and the conductivity of heat. Therefore, there is a possibility that the temperature detecting devices cannot detect the temperature of the power MOS transistor right. Also, there is a possibility that the power MOS transistor is destroyed due to the over-current in a period from when the power MOS transistor heats to when the heat is detected. Moreover, there is a case that excessive over-heat cannot be detected in case of operation at a high temperature, or there is a possibility that overheat is already detected so that a protection function operates to hinder a normal operation.

### CITATION LIST

[Patent Literature 1] JP 2007-315836A

### SUMMARY OF THE INVENTION

An output circuit is protected from transient over-current and over-heat, so that a power transistor at a rear stage is also protected. Other problems and new features will become clear from the description and the attached drawings.

According to an embodiment, a sensor resistance whose resistance value changes according to over-heat and over-current is connected in series between a power supply voltage and an output transistor. A control circuit section detects the over-heat or the over-current based on the change of an output voltage from the sensor resistance to generate a control signal. According to the control signal, the protection circuit section connects the output section and the ground (GND).

According to the embodiment, the output circuit is protected from the transient over-current and the over-heat so that the power transistor at a rear stage can be protected.

### BRIEF DESCRIPTION OF THE DRAWINGS

FIG. 1 is a circuit diagram showing a configuration example of a conventional output circuit.

FIG. 2 is a time chart showing a time change of voltage at each node of the conventional output circuit.

FIG. 3 is a time chart showing a time change of voltage at each node of the conventional output circuit in case of an extraordinary operation.

FIG. 4 is a circuit diagram showing a configuration example of an output load driving circuit in a first embodiment.

FIG. 5 is a block circuit diagram showing a configuration example of a semiconductor device in the first embodiment.

FIG. 6 is a circuit diagram showing the configuration of an output circuit in the first embodiment.

FIG. 7A shows graphs of characteristics of resistances in the first embodiment.

FIG. 7B is a diagram group showing a configuration example of the resistance.

FIG. 7C is a diagram group showing another configuration example of the resistance.

FIG. 7D shows a graph of a correlation example between dose quantity and resistance value in a resistance.

FIG. 8 is a circuit diagram showing a current flowing through each route in the output circuit of the first embodiment in case of an extraordinary operation.

FIG. 9 is a time chart showing a time change of voltage at each node of the output circuit in the first embodiment in case of the extraordinary operation.

FIG. 10 is a circuit diagram showing a configuration example of the output circuit in a second embodiment.

FIG. 11 is a circuit diagram showing current flowing through each route in the output circuit of the second embodiment in case of the extraordinary operation.

FIG. 12 is a time chart showing a time change of voltage at each node of the output circuit in the second embodiment in case of the extraordinary operation.

FIG. 13A is a circuit diagram showing a configuration example of the output circuit in a third embodiment.

FIG. 13B is a circuit diagram showing another configuration example of the output circuit in the third embodiment.

FIG. 14 is a circuit block diagram showing a configuration example of an AC servo system in a fourth embodiment.

FIG. 15 is a circuit block diagram showing a configuration example of a compressor unit of an air conditioner in a fifth embodiment.

### DESCRIPTION OF EMBODIMENTS

An output circuit with a protection function from over-heat and over-current, according to the embodiments of the present invention will be described below with reference to the attached drawings.

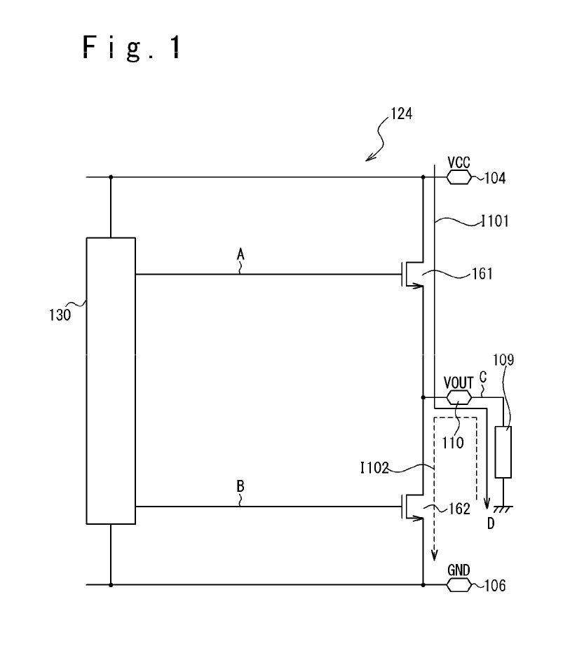

First, as a comparison object, a conventional output circuit will be described. FIG. 1 is a circuit diagram showing a configuration example of the conventional output circuit 124. The output circuit 124 shown in FIG. 1 has a drive logic circuit section 130, an output upper stage transistor 161, an output lower stage transistor 162 and an output terminal 110 (VOUT).

The drive logic circuit section 130 is connected between a power supply 104 (VCC) and the ground 106 (GND) and has a first output node A and a second output node B. The output upper stage transistor 161 is an N-channel transistor as an example and has a drain connected with the power supply 104, a gate connected with the first output node A of the drive logic circuit section 130 and a source connected with the output terminal 110. The output lower stage transistor is an N-channel transistor as an example and has a drain connected with the output terminal 110, a gate connected with the second output node B of the drive logic circuit section 130 and a source connected with the ground 106. Note that the output terminal 110 is connected with an external power transistor, which is shown as a load 109 in FIG. 1.

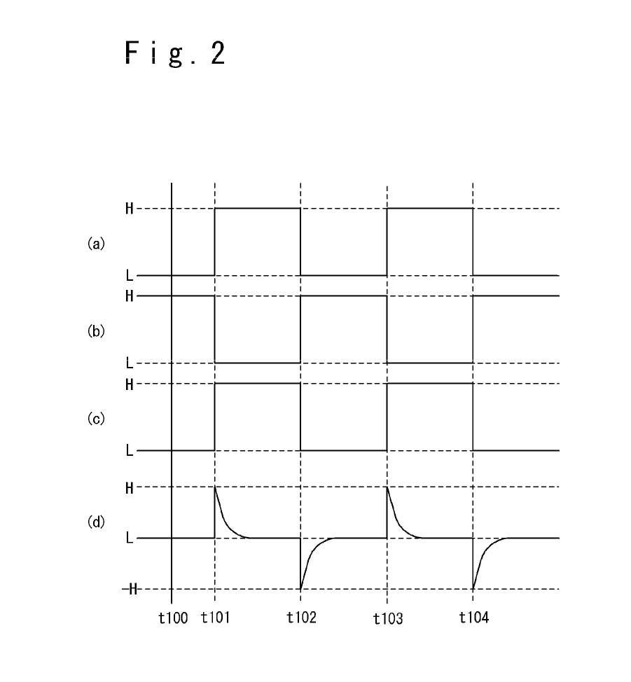

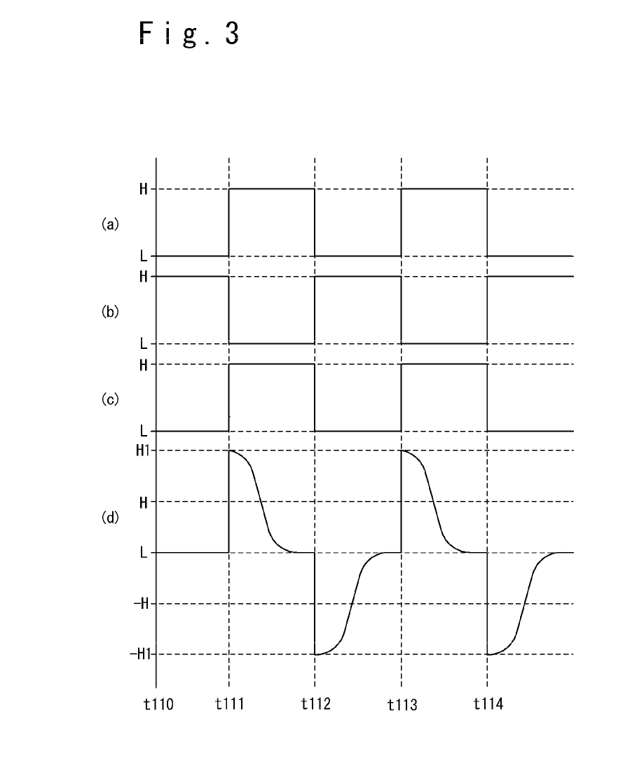

The drive logic circuit section 130 outputs a signal pair from the first output node A and the second output node B. For example, the signal pair may be a differential signal. The output upper stage transistor 161 amplifies and outputs one of signals of the signal pair to the output terminal 110. The output lower stage transistor amplifies and outputs the other of the signals of the signal pair to the output terminal 110. The signal outputted from the output terminal 110 is supplied to the load 109. An ordinary operation and an extraordinary operation of the output circuit shown in FIG. 1 will be described with reference to FIG. 2 and FIG. 3.

FIG. 2 is a time chart showing a time change of voltage at each node in the conventional output circuit in the ordinary operation. FIG. 2 contains four graphs (a) to (d). A first graph (a) shows the time change of voltage at the node A shown in FIG. 1, i.e. the first output node A of the drive logic circuit section 130. A second graph (b) shows the time change of voltage at the node B shown in FIG. 1, i.e. the second output node B of the drive logic circuit section 130. A third graph (c) shows the time change of voltage at a node C shown in FIG. 1, i.e. at the output terminal 110 (VOUT). A fourth graph (d) shows the time change of current which flows through the load 109. In each of the first graph (a) to the fourth graph (d), the horizontal axis shows time and the vertical axis shows voltage or current.

A state at a time t100 of FIG. 2 shows an initial state. Here, the voltage of the node A shown in the first graph (a) is in a low (L) state. The voltage of the node A shown in the second graph (b) is in a high (H) state. The voltage of the node C shown in the third graph (c) is in the low (L) state. The current of the load 109 shown in the fourth graph (d) is an off state (L). Here, the low state and the off state or the high state and the on state showing the value of the voltage or current in each graph, are independent in each voltage or each current, i.e. do not always show the same state and value.

At a time t101 shown in FIG. 2, the voltage of the node A rises up from the low (L) state to the high (H) state, and the voltage of the node B falls down from the high (H) state to the low (L) state. At this time, the output upper stage transistor 161 operates and the voltage of the node C rises up from the low (L) state to the high (H) state. Also, the current I101 shown in FIG. 1 is generated and charges the load 109 through the output upper stage transistor 161 and the output terminal 110 (VOUT) from the power supply 104 (VCC). This current rises up instantaneously and returns to the off state (L) immediately, as shown in the fourth graph (d).

At a time t102 shown in FIG. 2, the voltage of the node A falls down from the high (H) state to the low (L) state and the voltage of the node B rises up from the low (L) state to the high (H) state. At this time, the output lower stage transistor 162 operates, and the voltage of the node C falls down from the high (H) state to the low (L) state. Also, the current I102 shown in FIG. 1 is generated and the charge discharged by the load 109 destines for the ground 106 (GND) through the output terminal 110 (VOUT) and the output lower stage transistor. The current falls instantaneously and returns to the off state (L) immediately, as shown in the fourth graph (d).

At times t103 and t104 shown in FIG. 2, the operation described at the time t101 and time t102 is repeated.

FIG. 3 is a time chart showing a time change of voltage at each node of the conventional output circuit in case of an extraordinary operation. FIG. 3 contains four graphs (a) to (d). The first graph (a) shows the time change of voltage at the node A shown in FIG. 1, i.e. the first output node A of the drive logic circuit section 130. The second graph (b) shows the time change of voltage at the node B shown in FIG. 1, i.e. the second output node B of the drive logic circuit section 130. The third graph (c) shows the time change of the node C shown in FIG. 1, i.e. voltage at the output terminal 110 (VOUT). The fourth graph (d) shows the time change of current which flows through the load 109. In each of the first graph (a) to the fourth graph (d), the horizontal axis shows time and the vertical axis shows voltage or a current.

For example, the extraordinary state assumed here is in the following case. That is, the case is when the voltage or current applied to the load 109 is greater than an allowable voltage or an allowable current of the output upper stage transistor 161 or the output lower stage transistor.

An initial state is shown at a time t110 shown in FIG. 3. Here, the voltage of the node A shown in the first graph (a) is in the low (L) state. The voltage of the node A shown in the second graph (b) is in the high (H) state. The voltage of the node C shown in the third graph (c) is in the low (L) state. The current of the load 109 shown in the fourth graph (d) is the off state (L). The low state and the off state or the high state and the on state showing the values of the voltage or current shown by each graph here are independent persistently in each voltage or each current, i.e. they do not always show the same state and value.

At a time till shown in FIG. 3, the voltage of the node A rises up from the low (L) state to the high (H) state, and the voltage of node B falls from the high (H) state to the low (L) state. At this time, the output upper stage transistor 161 operates so as to raise the voltage of node C from the low (L) state to the high (H) state. Also, the current I101 shown in FIG. 1 is generated and flows from the power supply 104 (VCC) through the output upper stage transistor 161 and the output terminal 110 (VOUT) to charge the load 109. The current I101 rises at a moment as shown in the fourth graph (d), but is much greater than a current in the ordinary operation shown in FIG. 2 and also does not return to the off state (L) for a while.

At a time t112 shown in FIG. 3, the voltage of node A falls down from the high (H) state to the low (L) state, and the voltage of node B rises from the low (L) state to the high (H) state. At this time, the output lower stage transistor 162 operates so as to fall down the voltage of node C from the high (H) state to the low (L) state. Also, the current I102 shown in FIG. 1 is generated and a charge discharged by the load 109 flows for the ground 106 (GND) through the output terminal 110 (VOUT) and the output lower stage transistor 162. This current I102 rises at a moment as shown in the fourth graph (d), but is much greater than it of the ordinary operation shown in FIG. 2 and also does not return to the off state (L) for a while.

At times t113 and t114 shown in FIG. 3, the above-mentioned operation at the times till and t112 is repeated.

In this way, through the extraordinary operation shown in FIG. 3, the current I101 or I102 at the charging and discharging operation of the load 109 becomes great and also the time which is taken for the charging and discharging operation becomes long. Therefore, a large current continues to flow through the output upper stage transistor 161 and the output lower stage transistor 162 for a long time and exceeds a permission consumption power. As a result, the output upper stage transistor 161 and the output lower stage transistor 162 degrade in the characteristic due to its own heat and finally are destroyed.

Besides, in case that the output voltage is switched between the high state and the low state, and a fluctuation is generated between the power supply 104 (VCC) and the ground 106 (GND), and noise is superimposed and a jitter and so on is generated in case of switching of the output signal. When a large current or a pass-through current flows, an extraordinary state is caused as shown in FIG. 3. Also, when the switching of the output occurs through the higher-speed operation in a single pulse which is faster than the charging and discharging operation of the load 109, and the over-heat state occurs beyond the assumed permission power, an extraordinary state still occurs as shown in FIG. 3. In any case, the over-current state or the over-heat state occurs in the output upper stage transistor 161 and the output lower stage transistor 162 and the degradation and the destruction of the characteristics are brought about.

### First Embodiment

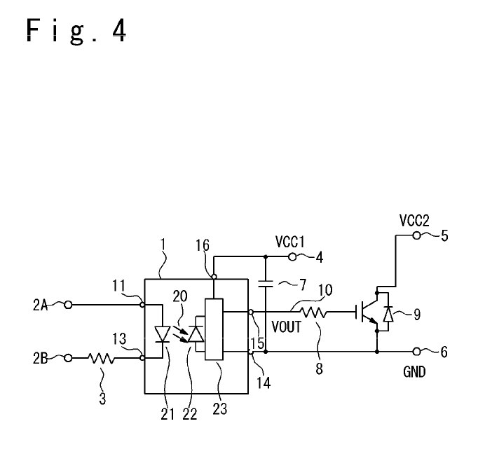

FIG. 4 is a circuit diagram showing a configuration example of the output load drive circuit according to a first embodiment.

The components of the output load driving circuit shown in FIG. 4 will be described. The output load driving circuit shown in FIG. 4 includes a semiconductor device 1, a first input node 2A, a second input node 2B, a resistance 3, a first power supply 4 (VCC1), a second power supply 5 (VCC2), the ground 6 (GND), a capacitance 7, a resistance 8 and the load 9 such as a power transistor.

The semiconductor device 1 shown in FIG. 4 is a photo-coupler as an example and has terminals 11, and 13 to 16, an optical signal transmitter 21, an optical signal receiver 22 and an output circuit 23. Also, the load 9 such as the power transistor shown in FIG. 4 is IGBT as an example, and has a gate, a collector and an emitter.

The connection relation of the components of the output load driving circuit shown in FIG. 4 will be described. The first input node 2A is connected with the input node of the optical signal transmitter 21 through the terminal 11 of the semiconductor device 1. The output node of the optical signal transmitter 21 is connected with the second input node 2B through the terminal 13 of the semiconductor device 1. The optical signal transmitter 21 and the optical signal receiver 22 are connected through an optical signal 20 generated and outputted by the transmitter 21 and received by the optical signal receiver 22. The input node and the output node of the optical signal receiver 22 are connected with the output circuit 23 through a middle circuit 24 to be described later. Note that the middle circuit 24 is omitted in FIG. 4. Besides, the output circuit 23 is connected in common with the ground 6, one end of the capacitance 7 and the emitter of the load 9 such as a power transistor through the terminal 14 of the semiconductor device 1. The output circuit 23 is connected with one end of the resistance 8 through the terminal 15 of the semiconductor device 1. The output circuit 23 is connected with the other end of the capacitance 7 and first power supply 4 (VCC1) in common through the terminal 16 of the semiconductor device 1. The other end of the resistance 8 is connected with the gate of the load 9 such as the power transistor. The collector of the load 9 such as the power transistor is connected with the second power supply 5 (VCC2).

The operation of components of the output load driving circuit shown in FIG. 4 will be described. The optical signal transmitter 21 is a light-emitting diode as an example, and converts the electrical signal supplied from the first input node 2A and the second input node 2B into the optical signal 20. The optical signal receiver 22 is a photodiode as an example, and receives the optical signal and converts the optical signal 20 into another electric signal to output it to the output circuit 23. The output circuit 23 amplifies and outputs the other electric signal supplied from the optical signal receiver 22 to the load 9 such as the power transistor. The load 9 carries out an amplification operation according to the signal supplied from the output circuit 23.

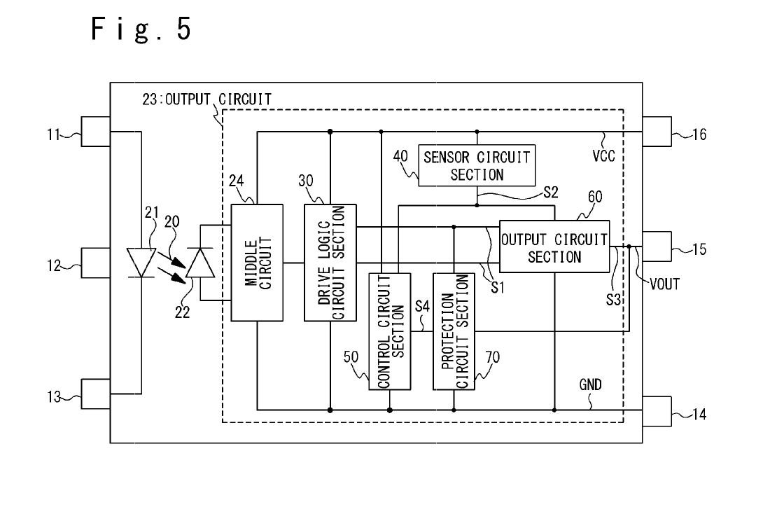

FIG. 5 is a block diagram showing a configuration example of the semiconductor device 1 according to the first embodiment. The semiconductor device 1 shown in FIG. 5 shows the more detailed configuration example of the output circuit 23 of the semiconductor device 1 shown in FIG. 4. The output circuit 23 of the first embodiment will be described below. Because the components shown in FIG. 4 are described above with reference to FIG. 4, the description is omitted.

The components of the output circuit 23 shown in FIG. 5 will be described. The output circuit 23 has a drive logic circuit section 30, a sensor circuit section 40, a control circuit section 50, an output circuit section 60 and a protection circuit section 70.

The connection relation of the components of the output circuit 23 shown in FIG. 5 will be described. The input node and the output node of the optical signal receiver 22 are connected with a middle circuit 24. The output node of the middle circuit 24 is connected with the input node of the drive logic circuit section 30. Two output nodes of the drive logic circuit section 30 are connected with two input nodes of the output circuit section 60, respectively. An output node of the output circuit section 60 is connected with the output node 10 (VOUT) of the output circuit 23 shown in FIG. 4 through the terminal 15. The first power supply 4 (VCC) shown in FIG. 4 is connected with the middle circuit 24, the drive logic circuit section 30, the sensor circuit section 40 and the control circuit section 50 through the terminal 16. The ground 6 (GND) shown in FIG. 4 is connected with the middle circuit 24, the drive logic circuit section 30, the output circuit section 60 and the protection circuit section 70 through the terminal 14. The sensor circuit section 40 is connected between the first power supply 4 (VCC1) shown in FIG. 4 and the output circuit section 60 and moreover is connected with control circuit section 50. The control circuit section 50 is connected with the first power supply 4 (VCC) shown in FIG. 4 and the sensor circuit section 40 and moreover is connected with the protection circuit section 70. The protection circuit section 70 is connected with the control circuit section 50 and is connected with the ground 6 (GND) shown in FIG. 4. Moreover, the protection circuit section 70 is connected with either or both of one of the two output node of the drive logic circuit section 30 and the output node 10 (VOUT).

In other words, the power supply 4 (VCC), the sensor circuit section 40, the output circuit section 60 and the ground 6 (GND) are connected in series in this order.

The operation of the components of the output circuit 23 shown in FIG. 5 will be described. The drive logic circuit section 30 receives another electric signal supplied from the optical signal receiver 22 through the middle circuit 24 and converts it into a signal pair (S1) such as a differential signal to be outputted. The output circuit section 60 amplifies the signal pair (S1) supplied from the drive logic circuit section 30 and outputs for the output terminal 10 (VOUT) (S3). When the output circuit section 60 operates, the temperature of the sensor circuit section 40 changes through the current flowing from the first power supply 4 (VCC) to the ground 6 (GND). The sensor circuit section 40 outputs a temperature change voltage group (S2) in which the output voltage changes due to the change of this temperature, to the control circuit section 50. The control circuit section 50 generates a control signal group (S4) according to the change of the output voltage supplied from the sensor circuit section 40 and outputs it to the protection circuit section 70. The protection circuit section 70 connects one or both of the signals of the pair (S1) to the output terminal (VOUT) or the ground 6 (GND) according to the control signal group (S4) supplied from the control circuit section 50.

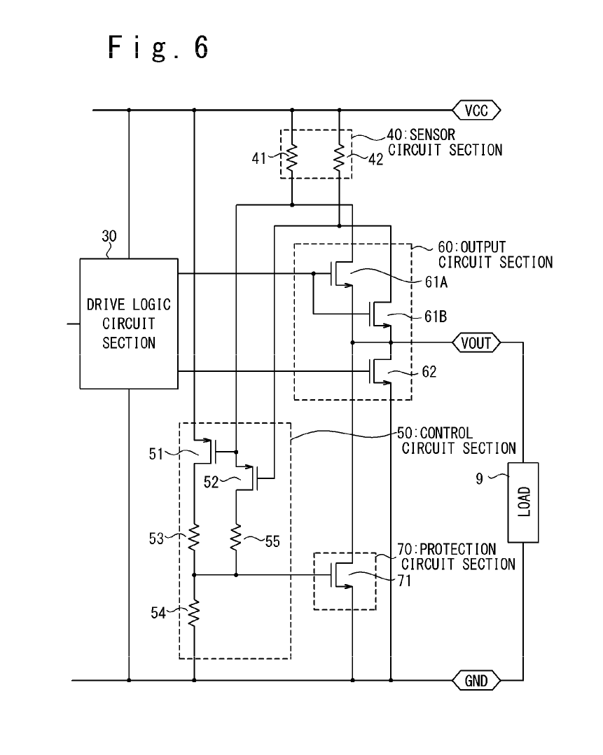

FIG. 6 is a circuit diagram showing the configuration of the output circuit 23 in the first embodiment.

The components of the output circuit 23 shown in FIG. 6 will be described. The output circuit 23 shown in FIG. 6 includes the middle circuit 24, the drive logic circuit section 30, the sensor circuit section 40, the control circuit section 50, the output circuit section 60 and the protection circuit section 70, like the output circuit 23 shown in FIG. 5. However, the middle circuit 24 is omitted in FIG. 6.

The sensor circuit section 40 shown in FIG. 6 has a first sensor resistance 41 and a second sensor resistance 42. Here, the resistance values of the first sensor resistance 41 and the second sensor resistance 42 change according to their own temperature changes. It is important that the temperature coefficients which define these temperature changes are different from each other in the first sensor resistance 41 and the second sensor resistance 42.

The control circuit section 50 shown in FIG. 6 has a first control transistor 51, a second control transistor 52, a first voltage dividing resistance 53, a second voltage dividing resistance 54 and a third voltage dividing resistance 55. Here, the first control transistor 51 and the second control transistor 52 are P-channel FETs.

The output circuit section 60 shown in FIG. 6 has a first output upper stage transistor 61A, a second output upper stage transistor 61B and an output lower stage transistor 62. Here, the first output upper stage transistor 61A and the second output upper stage transistor 61B and the output lower stage transistor 62 are N-channel transistors. It is desirable that a total ability of the first output upper stage transistor 61A and the second output upper stage transistor 61B is same as the ability of the output lower stage transistor 62. Also, it is desirable that the first output upper stage transistor 61A and the second output upper stage transistor 61B have the same ability.

The protection circuit section 70 shown in FIG. 6 has a protection transistor 71. Here, the protection transistor 71 is an N-channel transistor.

The connection relation of the components shown in FIG. 6 will be described. The power supply 4 (VCC) is connected with the drive logic circuit section 30, one end of the first sensor resistance 41, one end of the second sensor resistance 42, and the source of the first control transistor 51 in common. The other end of the first sensor resistance 41 is connected with the gate of the first control transistor 51, the source of the second control transistor 52 and the drain of the first output upper stage transistor 61A in common. The other end of the second sensor resistance 42 is connected with the gate of the second control transistor 52 and the drain of the second output upper stage transistor 61B in common.

The drain of the first control transistor 51 is connected with one end of the first voltage dividing resistance 53. The drain of the second control transistor 52 is connected with one end of the third voltage dividing resistance 55. The other end of the first voltage dividing resistance 53 is connected with one end of the second voltage dividing resistance 54 and the other end of the third voltage dividing resistance 55 and the gate of the protection transistor 71 in common.

One of the output nodes of the drive logic circuit section 30 is connected with the gate of the first output upper stage transistor 61A and the gate of the second output upper stage transistor 61B in common. The other output node of the drive logic circuit section 30 is connected with the gate of the output lower stage transistor 62. The source of the first output upper stage transistor 61A, the source of the second output upper stage transistor 61B, the drain of the output lower stage transistor 62 and the drain of the protection transistor 71 are connected with the output terminal 10 (VOUT) in common. The drive logic circuit section 30 and the other end of the second voltage dividing resistance 54, the source of the protection transistor 71 and the source of the output lower stage transistor 62 are connected with the ground 6 (GND) in common. The output terminal 10 (VOUT) is connected with the external load 9.

In other words, the power supply 4 (VCC), the first sensor resistance 41, and the first output upper stage transistor 61A and the output terminal 10 (VOUT), the output lower stage transistor 62 and the ground 6 (GND) are connected in series in this order. In the same way, the power supply 4 (VCC), the second sensor resistance 42, the second output upper stage transistor 61B, the output terminal 10 (VOUT), the output lower stage transistor 62 and the ground 6 (GND) are connected in series in this order.

Also, the power supply 4 (VCC), the first control transistor 51, the first voltage dividing resistance 53, the second voltage dividing resistance 54 and the ground 6 (GND) are connected in series in this order. In the same way, the power supply 4 (VCC), the first sensor resistance 41, the second control transistor 52, the third voltage dividing resistance 55, the second voltage dividing resistance 54 and the ground 6 (GND) are connected in series in this order.

Because the other configuration of the output circuit 23 shown in FIG. 6 is same as that of the example shown in FIG. 5, further detailed description is omitted.

The overall operation of the components shown in FIG. 6 will be described. First, the drive logic circuit section 30 outputs a signal pair. Here, it is supposed that each of signals of this signal pair is a digital binary signal, one of the signals of the pair is in the high state while the other signal is in the low state.

When one of the signals of the pair which is outputted from a corresponding one of the output nodes of the drive logic circuit section 30 becomes high, the first output upper stage transistor 61A and the second output upper stage transistor 61B are turned on. When the first output upper stage transistor 61A is turned on, the current flows through the first sensor resistance 41. This current reaches the output terminal 10 (VOUT), flowing from the power supply 4 (VCC) through the first sensor resistance 41 and the first output upper stage transistor 61A in this order. When the current flows through the first sensor resistance 41, the Joule heat is generated and the first sensor resistance 41 is heated. When the first sensor resistance 41 is heated, the resistance value changes according to this temperature change.

In the same way, when the second output upper stage transistor 61B is turned on, the current flows through the second sensor resistance 42. The current flows from the power supply 4 (VCC) to the output terminal 10 (VOUT) through the second sensor resistance 42 and the second output upper stage transistor 61B in this order. When the current flows through the second sensor resistance 42, the Joule heat is generated so that the second sensor resistance 42 is heated. When the second sensor resistance 42 is heated, the resistance value changes according to this temperature change.

Here, the first sensor resistance 41 and the second sensor resistance 42 are provided such that a difference in the change of the resistance value due to the temperature change is generated between the first sensor resistance 41 and the second sensor resistance 42. For this purpose, it is sufficient that two sensor resistances different in the temperature coefficient showing the relation of the temperature change and the change of the resistance value are used.

When there is a difference in the change of the resistance value according to a temperature change between the first sensor resistance 41 and the second sensor resistance 42, the voltage between the source and gate of the second control transistor 52 changes. By determining whether or not the change of this voltage exceeds a predetermined threshold value, it is possible to determine whether or not an extraordinary event due to the over-heat occurred. In other words, the first sensor resistance 41 and the second sensor resistance 42 need to be selected appropriately in the resistance value and the temperature coefficient so as to be a reference to determine the generation of the extraordinary event due to the over-heat.

A case where the extraordinary event due to the over-heat has occurred will be described. When the voltage between the source and gate of the second control transistor 52 exceeds a predetermined threshold value, the second control transistor 52 turns on. In more detail, when the following relational equation is met, the second control transistor 52 turns on:

VTH52<TGS52=R42×I42−R41×I41

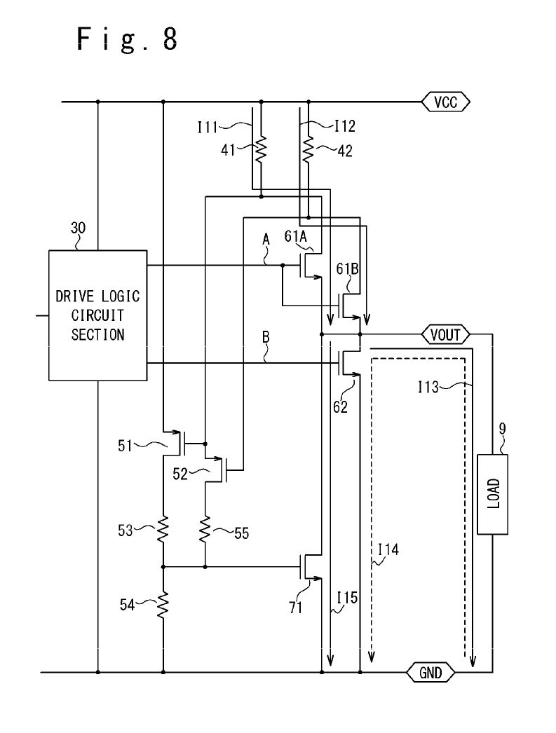

Here, VTH52 and TGS52 show the threshold voltage of the second control transistor 52, and the gate-source voltage, respectively. R41 and I41 show the resistance value of the first sensor resistance 41 and the current value of the flowing current, respectively. R42 and I42 show the resistance value of the second sensor resistance 42 and the current value of the flowing current, respectively. Note that the currents which flow through the first sensor resistance 41 and the second sensor resistance 42 are referred to as the first current I11 and the second current I12, respectively, as shown in FIG. 8 to be described later.

When the second control transistor 52 is turned on, a current flows from the power supply 4 (VCC) to the ground 6 (GND) through the first sensor resistance 41, the second control transistor 52, the third voltage dividing resistance 55, and the second voltage dividing resistance 54 in this order. As a result, a voltage generated between the drain of the second control transistor 52 and the ground 6 (GND) is divided in voltage by the third voltage dividing resistance 55 and the second voltage dividing resistance 54, and a voltage obtained through the voltage division is applied to the gate of the protection transistor 71. It is important that the resistance values of the third voltage dividing resistance 55 and the second voltage dividing resistance 54 are set appropriately so that the protection transistor 71 is turned on in response to the application of this voltage. The voltage applied to the gate of the protection transistor 71, i.e. a signal generated by the control circuit section 50 and outputted to the protection circuit section 70 is referred to as a control signal hereinafter.

When the protection transistor 71 is turned on in response to the control signal, a current flows from the output terminal 10 (VOUT) to the ground 6 (GND) through the protection transistor 71. At this time, a part of a total current flowing to the output terminal 10 (VOUT) through the first output upper stage transistor 61A and the second output upper stage transistor 61B flows to the ground 6 (GND) through the protection transistor 71. Therefore, the current flowing from the output terminal 10 (VOUT) to the load 9 decreases by that part. In this way, the output circuit 23 shown in FIG. 6 can protect the load 9 from excessive current associated with the extraordinary event due to the over-heat.

Also, the output circuit shown in FIG. 6 can protect the load 9 from the excessive current associated with an extraordinary event due to the over-current. That is, here, the resistance value of the first sensor resistance 41 and the characteristics of the first control transistor 51 are appropriately set in advance such that the first control transistor 51 is turned on when the current which flows through the first sensor resistance 41 exceeds a predetermined threshold value. In detail, when the following relational equation is satisfied, the first control transistor 51 is turned on:

VTH51<TGS51=R41×I41

Here, VTH51 and TGS51 show a threshold voltage of the first control transistor 51, and the gate-source voltage thereof, respectively. R41 and I41 show a resistance value of the first sensor resistance 41 and a current value of the flowing current, respectively.

When the first control transistor 51 is turned on, the current flows from the power supply 4 (VCC) to the ground 6 (GND) through the first control transistor 51, the first voltage dividing resistance 53 and the second voltage dividing resistance 54 in this order. As a result, a voltage generated between the drain of the first control transistor 51 and the ground 6 (GND) is subjected to a voltage division by the first voltage dividing resistance 53 and the second voltage dividing resistance 54 and is applied to the gate of the protection transistor 71. Because the subsequent operation is the same as the case where the extraordinary event due to the over-heat has occurred, further detailed description is omitted.

The change of the resistance values of the first sensor resistance 41 and the second sensor resistance 42 would be described in detail.

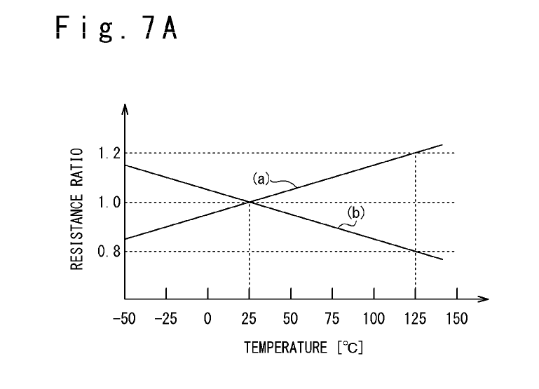

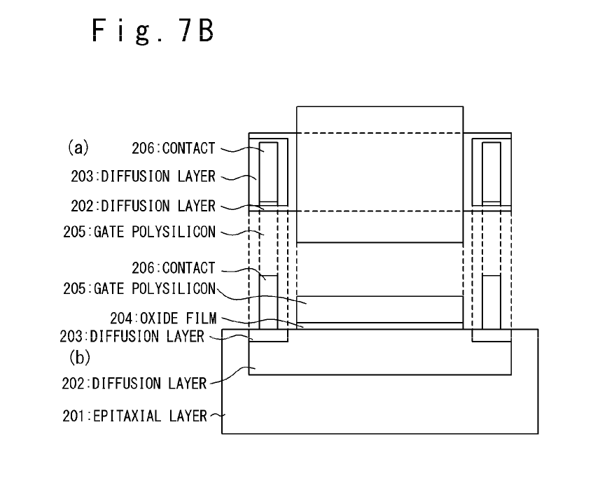

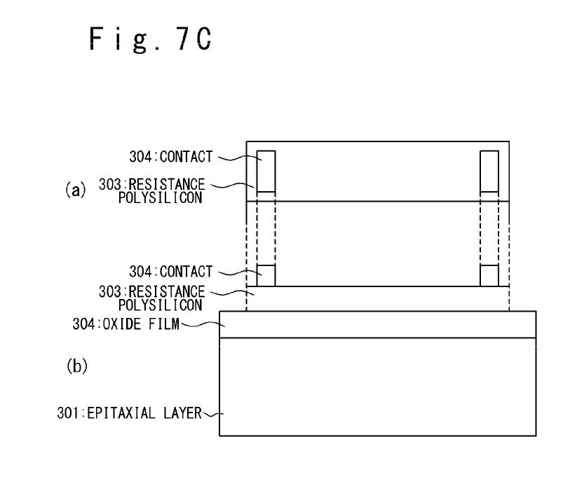

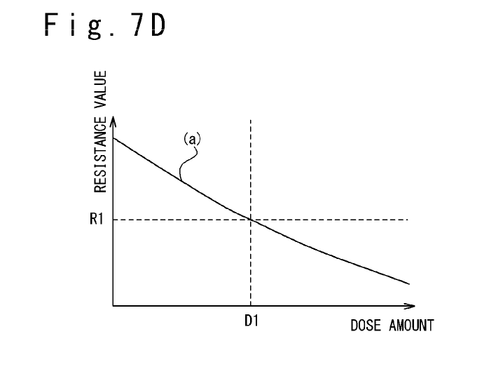

FIG. 7A is a graph showing the characteristic of each of the resistances 41 and 42 in the first embodiment. The graph shown in FIG. 7A contains a first graph (a) and s second graph (b). The two graphs (a) and (b) show examples of the resistance values which change according to the temperature change, respectively. In the both graphs, a horizontal axis shows a temperature and the vertical axis shows a resistance ratio. Here, the resistance ratio represents a ratio of a resistance value of a resistance to a reference resistance value at the temperature of 25° C. as an example.

The first graph (a) shows an example that the resistance value increases as the temperature rises. Oppositely, the second graph (b) shows an example that the resistance value decreases as the temperature rises. For example, these relation equations can be shown as follows.

R(T)/R(25° C.)=1+T×α

Here, R(T) shows a resistance value at the temperature of T, R(25° C.) shows a resistance value at the temperature of 25° C. as the reference resistance value, T shows a temperature and α shows a temperature coefficient. Note that the unit of temperature T is K (Kelvin) and the unit of temperature coefficient α is ppm/K.

The first graph (a) shows a temperature change characteristic of the resistance value of the resistance having the first temperature coefficient al of +2000 ppm/K in an example shown in FIG. 7A. In the same way, the second graph (b) shows a temperature change characteristic of the resistance value of the resistance having the second temperature coefficient α2 of −2000 ppm/K. In such a case, the resistance ratio in the first graph (a) is equal to “1” at the temperature of 25° C. and is equal to 1.2 at the temperature of 125° C., as shown in FIG. 7A. Also, the resistance ratio in the second graph (b) is equal to 1 at the temperature of 25° C. and is equal to 0.8 at the temperature of 125° C.

Here, as one example, it is supposed that the first graph (a) shows the characteristic of the second sensor resistance 42, and that the second graph (b) shows the characteristic of the first sensor resistance 41. However, a selection in which the temperature coefficient of the second sensor resistance 42 is positive, and the temperature coefficient of the first sensor resistance 41 is negative, is only an example persistently. The positive and negative temperature coefficients may be opposite, and both of the temperature coefficients may be positive or negative. It is important that the temperature coefficients of the two sensor resistances are different from each other. However, it is necessary that the other parameter can be adjusted according to the selection of the temperature coefficient, e.g. the polarity of the control transistor can be adjusted appropriately so as for the output circuit 23 to operate right.

FIG. 7B is a group of diagrams showing one configuration example of the resistance. FIG. 7B contains a first diagram (a) and a second diagram (b). The first diagram (a) and the second diagram (b) in FIG. 7B show a top view and a sectional view of the resistance in the same configuration example.

The resistance in the configuration example shown in FIG. 7B is a so-called diffusion resistance, and has an epitaxial layer 201, a first diffusion layer 202, a second diffusion layer 203, an oxide film 204, a gate polysilicon 205 and a contact 206.

The first diffusion layer 202 is formed on the epitaxial layer 201. The second diffusion layers 203 are formed on the first diffusion layer 202. The oxide film 204 is formed on the first diffusion layer 202. The gate polysilicon layer 205 is formed on the oxide film 204. The contacts 206 are formed on the second diffusion layers 203.

Generally, the diffusion resistance functions as an element having a resistance value between the two contacts 206 by implanting impurity into the drain region or source region of the MOS (Metal Oxide Semiconductor) transistor or a well region.

FIG. 7C is a diagram group showing another configuration example of the resistance. FIG. 7C contains a first diagram (a) and a second diagram (b). The first diagram (a) and the second diagram (b) in FIG. 7C show a top view and a sectional view of the resistance of the same configuration example, respectively.

The resistance of the configuration example shown in FIG. 7C is a so-called polysilicon resistance and has an epitaxial layer 301, an oxide film 302, a resistance polysilicon layer 303 and contacts 304.

The oxide film 302 is formed on the epitaxial layer 301. The resistance polysilicon layer 303 is formed on the oxide film 302. The contacts 304 are formed on the resistance polysilicon layer 303.

Generally, the polysilicon resistance functions as an element which has a resistance value between the two contacts 304 by forming the polysilicon layer which is originally used as a gate electrode of the MOS transistor in a region except for a region of the gate oxide film. An impurity can be implanted into the resistance polysilicon layer, and it is possible to produce the resistance which has a high resistance value.

In case of the diffusion resistance, and in case of the polysilicon resistance, there is a correlation between a dose quantity of impurity to be implanted and the resistance value obtained as the result of the implantation. FIG. 7D is a graph showing an example of the correlation of the dose quantity and the resistance value in the resistance. The graph (a) in FIG. 7D shows an example of the correlation between the dose quantity and the resistance value, and the horizontal axis shows dose quantity and the vertical axis shows resistance value. The example in FIG. 7D shows that the resistance having a resistance value R1 is obtained by implanting the impurity for a dose quantity D1. Note that generally, it is possible to suppress a precision of the resistance value below about ±20%.

FIG. 8 is a circuit diagram showing a current which flows through each route in the output circuit according to the first embodiment in case of the extraordinary operation. In the circuit diagram shown in FIG. 8, frames showing of the sensor circuit section 40, the control circuit section 50, the output circuit section 60 and the protection circuit section 70 are deleted from the circuit diagram shown in FIG. 6. In addition, an arrow showing each current which flows through each component is added in case of the operation of the output circuit 23. Therefore, further detailed description of the configuration of the circuit shown in FIG. 8 is omitted in this case.

The circuit diagram shown in FIG. 8 contains five arrows which show a first current I11 to a fifth current I15. The first current I11 flows from the power supply 4 (VCC) to the output terminal 10 (VOUT) through the first sensor resistance 41 and the first output upper stage transistor 61A in this order when the first output upper stage transistor 61A operates according to one of the outputs of the drive logic circuit section 30. In the same way, the second current I12 flows from the power supply 4 (VCC) to the output terminal 10 (VOUT) through the second sensor resistance 42 and the second output upper stage transistor 61B in this order, when the second output upper stage transistor 61B operates according to one of the outputs of the drive logic circuit section 30. The first current I11 and the second current I12 which reaches the output terminal 10 (VOUT) flow as a third current I13 externally from the output terminal 10 and the load 9 is charged with the third current I13.

On the contrary, in case that the output lower stage transistor 62 operates according to the other output from the drive logic circuit section 30, the charge charged in the load 9 flows as a fourth current I14 to the ground 6 (GND) through the output terminal 10 (VOUT) and the output lower stage transistor 62 in this order.

The first current I11 to the fourth current I14 which have been described above flow when the output circuit 23 operates normally. On the other hand, when the extraordinary event such as the over-heat and the over-current has occurred in the output circuit 23, the fifth current I15 flows as described below.

The fifth current I15 flows from the output terminal 10 (VOUT) to the ground 6 (GND) through the protection transistor 71 when the first output upper stage transistor 61A and the second output upper stage transistor 61B operate, and moreover the extraordinary event such as the over-heat and the over-current is detected.

Because the fifth current I15 flows, only a part of the total current of the first current I11 and the second current I12 is outputted from the output terminal 10 (VOUT) as the third current I13. In other words, the part of the total current of the first current I11 and the second current I12 is thrown away to the ground 6 (GND) as the fifth current I15, and the remaining part is outputted from the output terminal 10 (VOUT) as the third current I13. As a result, even if the total current of the first current I11 and the second current I12 is too great, it is possible to protect the load 9.

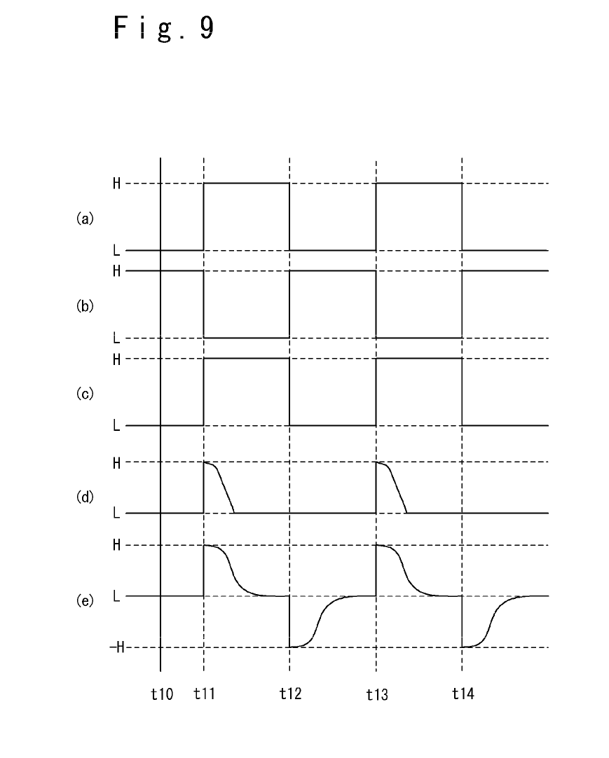

FIG. 9 is a time chart showing a time change of voltage at each node in the output circuit according to the first embodiment in case of the extraordinary operation. Referring to FIG. 9, the operation of the output circuit 23 shown in FIG. 6 and FIG. 8 will be described in detail.

FIG. 9 contains five graphs (a) to (e). The first graph (a) shows an example of the time change of voltage at the node which connects the node A shown in FIG. 8, i.e. one of the outputs of the drive logic circuit section 30, and the gate of the first output upper stage transistor 61A and the gate of the second output upper stage transistor 61B. The second graph (b) shows an example of the time change of voltage at the node which connects the node B shown in FIG. 8, i.e. the other output of the drive logic circuit section 30, and the gate of the output lower stage transistor 62. The third graph (c) shows an example of the time change of voltage at a connection node of the node C shown in FIG. 8, i.e. the output terminal 10 (VOUT) and the load 9 outside the output circuit 23. The fourth graph (d) shows an example of the time change of the fifth current I15 shown in FIG. 8. The fifth graph (e) shows an example of the time change of the third current I13 shown in FIG. 8.

In each of the first graphs (a) to the fifth graphs (e) shown in FIG. 9, the horizontal axis shows time and the vertical axis shows voltage or current. Note that in each graph, “H” shows a high state or an on state and “L” shows a low state or an off state. However, they are only representation on convenience, and specific values are may be different for every graph.

A time t10 shown in FIG. 9 shows an initial state. Here, the voltage of the node A shown in the first graph (a) is in the low (L) state, and the voltage of the node A shown in the second graph (b) is in the high (H) state. The voltage of the node C shown in the third graph (c) is in the low (L) state and the fifth current shown in the fourth graph (d) is in the off (L) state, and the third current shown in the fifth graph (e) is in the off (L) state.

At a time t11 shown in FIG. 9, the voltage of the node A rises up from the low (L) state to the high (H) state, and the voltage of the node B falls down from the high (H) state to the low (L) state. At this time, the first output upper stage transistor 61A and the second output upper stage transistor 61B are turned on, the output lower stage transistor 62 is turned off, and the voltage of the node C rises up from the low (L) state to the high (H) state. As a result, the first current I11 and the second current I12 shown in FIG. 8 are generated. At this time, the extraordinary event due to the over-heat and the over-current occurs, and even if the excessive current tries to flow from the output terminal 10 (VOUT) for the load 9 like the fourth graph (d) shown in FIG. 3, the fifth current I15 flows from the output terminal 10 for the ground 6 (GND) for the fourth graph (d) shown in FIG. 9. As a result, the current which actually flows from the output terminal 10 (VOUT) for the load 9 is settled at the degree of the fifth graph (e) shown in FIG. 9 which is less for the fourth graph (d) shown in FIG. 9 than the fourth graph (d) shown in FIG. 3. The third current I13 shown in FIG. 8 and shown by the fifth graph (e) in FIG. 9 charges the load 9, and then returns to the off (L) state.

At a time t12 shown in FIG. 9, the voltage of the node A falls down from the high (H) state to the low (L) state and the voltage of the node B rises up from the low (L) state to the high (H) state. At this time, the first output upper stage transistor 61A and the second output upper stage transistor 61B are turned off, and the output lower stage transistor 62 is turned on, so that the voltage of the node C falls down to the low (L) state from the high (H) state. As a result, the fourth current I14 shown in FIG. 8 is generated. Because the fourth current I14 flows in the direction opposite to the direction of the third current I13, the current is represented as a negative current in the fifth graph (e) shown in FIG. 9. Note that this negative current flows for the charge charged in the load 9 and returns to the off (L) state. Also, as long as the first output upper stage transistor 61A and the second output upper stage transistor 61B are in the off state, the current does not flow through the first sensor resistance 41 and the second sensor resistance 42. Therefore, the control circuit section 50 and the protection circuit section 70 do not operate and the fourth graph (d) shown in FIG. 9 does not change from the off (L) state.

At times t13 and t14 shown in FIG. 9, the operation described at the times t11 and t12 is repeated.

As described above, according to the output circuit 23 shown in FIG. 6 and FIG. 8, the drive logic circuit section 30 generates and outputs the signal pair. The output circuit section 60 amplifies one of signals of this signal pair and outputs it from the output terminal 10 (VOUT). The sensor circuit section 40 detects the over-heat or the over-current according to the current which flows at this time. The control circuit section 50 generates and outputs a control signal according to this detection result. The protection circuit section 70 connects the output terminal 10 (VOUT) to the ground 6 (GND) in response to this control signal. As a result, the load 9 connected with the output terminal 10 (VOUT) can be protected from the excessive current.

Also, according to the output circuit 23 shown in FIG. 6 and FIG. 8, by using both of an over-heat detecting function and an over-current detecting function, it is possible to detect the generation of the heat to destroy the load 9, to drive the protection circuit section 70, and to ease an adverse influence of the over-current and the over-heat, in case where the output current at the time of turning-on is below an upper limit in addition to the case where the output current of the upper limit flows.

Moreover, the output circuit 23 shown in FIG. 6 and FIG. 8 has the following excellent characteristics, compared with the above-mentioned conventional technique.

Because it operates at the time of turning-on when the switching is carried out, it is not necessary to always consume a stand-by current for the purpose of detection of the over-heat and the over-current.

Because the current flows through the resistance used as the sensor, it is possible to obtain the reaction which is sensitive to the change of the heat and also to set a threshold value of the over-current and the over-heat freely.

When the extraordinary event due to the over-heat and the over-current is detected, the protection circuit section 70 operates to supply the current for the over-current from the output terminal 10 (VOUT) to the ground 6 (GND) to reduce the current to the load 9.

Because the two output upper stage transistors are connected with the output terminal 10 (VOUT) in parallel and moreover the protection transistor 71 is connected, the current which flows through the output terminal 10 (VOUT) flows through the respective transistors in parallel so that the generated Joule heat can be distributed.

Because the protection transistor 71 operates only at the time of turning-on, a usual high-speed switching operation is possible even in case of the over-heat and the over-current.

In case where the drive logic circuit section outputs a single signal not the signal pair, the output lower stage transistor 62 is removed. Even in this case, the advantages of the present invention can be achieved sufficiently.

### Second Embodiment

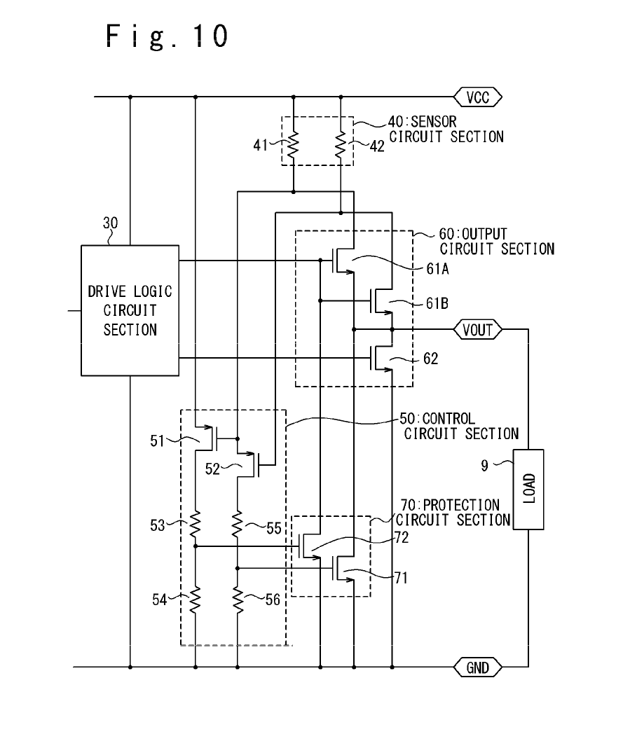

FIG. 10 is a circuit diagram showing the configuration of the output circuit according to the second embodiment.

The components of the output circuit shown in FIG. 10 will be described. The output circuit shown in FIG. 10 has the drive logic circuit section 30, the sensor circuit section 40, the control circuit section 50, the output circuit section 60, the protection circuit section 70 and the output terminal 10 like the output circuit shown in FIG. 6.

The components of the output circuit shown in FIG. 10 will be described in detail. The components shown of the output circuit shown in FIG. 10 is same as the addition result of the following components to the components of the output circuit in the first embodiment shown in FIG. 6. That is, the output circuit shown in FIG. 10 has a fourth voltage division resistance 56 and the second protection transistor 72 in addition to the components of the output circuit shown in FIG. 6.

Note that The component of the output circuit shown in FIG. 10 corresponding to the component called “the protection transistor 71” in the description of the output circuit shown in FIG. 6 is called “a first protection transistor 71” hereinafter. The control signal supplied to the gate of the first protection transistor 71 is called “the first control signal” hereinafter. Moreover, the control signal supplied to the gate of the second protection transistor 72 is called “a second control signal”. The second protection transistor 72 is an N-channel transistor, like the first protection transistor 71.

In other words, the control circuit section 50 shown in FIG. 10 has the fourth voltage division resistance 56 in addition to the components of the control circuit section 50 shown in FIG. 6. Also, the protection circuit section 70 shown in FIG. 10 has the second protection transistor 72 in addition to the components of the protection circuit section 70 shown in FIG. 6.

The description of components common to the components of the output circuit shown in FIG. 6, of the components of the output circuit shown in FIG. 10, is omitted.

The connection relation of the components of the output circuit shown in FIG. 10 will be described. Compared with the connection relation of the components of the output circuit shown in FIG. 6, a connection node of the third voltage dividing resistance 55 and the gate of the first protection transistor 71 is not connected with a connection node between the first voltage dividing resistance 53 and the second voltage dividing resistance 54 in the output circuit shown in FIG. 10. Instead, the connection node of the third voltage dividing resistance 55 and the gate of the first protection transistor 71 is connected with the ground 6 (GND) through the fourth voltage division resistance 56.

Next, the connection node between the first voltage dividing resistance 53 and the second voltage dividing resistance 54 is connected with the gate of the second protection transistor 72. The drain of the second protection transistor 72 is connected with a connection node between one of the output nodes of the drive logic circuit section 30, the gate of the first output upper stage transistor 61A and the gate of the second output upper stage transistor 61B. The source of the second protection transistor 72 is connected with the ground 6 (GND).

Further detailed description of a part common to the connection relation of the components of the output circuit shown in FIG. 6, of the connection relation of the components of the output circuit shown in FIG. 10 is omitted.

The overall operation of the components shown in FIG. 10 will be described.

First, the operation when an extraordinary event due to the over-heat has occurred is almost same as the operation of the output circuit in the first embodiment shown in FIG. 6 and FIG. 8. A difference is present only in that the first control signal supplied to the gate of the first protection transistor 71 is generated by a voltage division circuit of the third voltage dividing resistance 55 and the fourth voltage division resistance 56 in the second embodiment, not by the voltage division circuit of the third voltage dividing resistance 55 and the second voltage dividing resistance 54 like the first embodiment. Therefore, further detailed description is omitted.

Next, a difference of the case where the extraordinary event due to the over-current has occurred from the case of the output circuit in the first embodiment shown in FIG. 6 and FIG. 8 will be described. In the present embodiment, it is assumed that a current which is larger than the over-current in the first embodiment flows.

When the first control transistor 51 is turned on and the second control signal is generated from the connection node between the first voltage dividing resistance 53 and the second voltage dividing resistance 54, the second control signal is supplied to the gate of the second protection transistor 72. At this time, the gates of the first output upper stage transistor 61A and the second output upper stage transistors 61B are connected with the drain of the second protection transistor 72 which connects the gates of the transistors 61A and 61B to the ground 6 (GND). As a result, the first output upper stage transistor 61A and the second output upper stage transistor 61B are turned off compulsorily. Thus, it is possible to compulsorily stop the supply of the current to the load 9 at the time of turning-on.

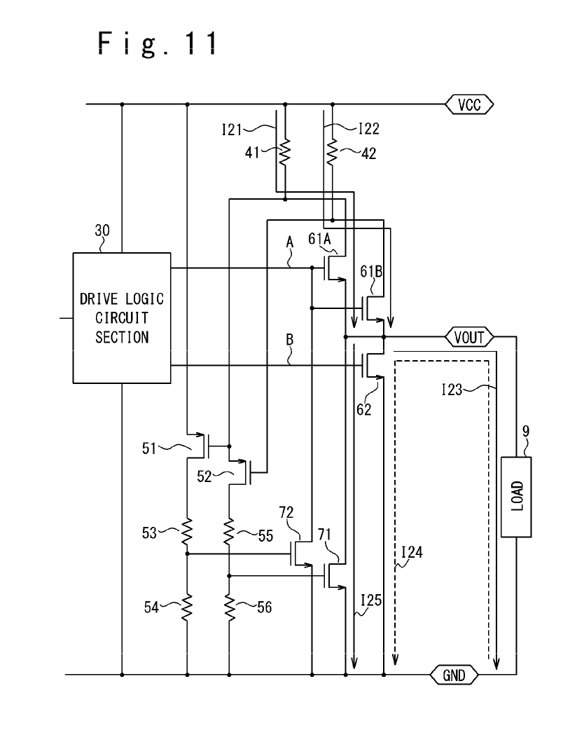

FIG. 11 is a circuit diagram showing a current which flows through each route in case of the extraordinary operation in the output circuit in the second embodiment. FIG. 11 shows the circuit diagram by deleting the frames showing the sensor circuit section 40, the control circuit section 50, the output circuit section 60 or the protection circuit section 70 from the circuit diagram shown in FIG. 10, and by adding the arrow showing each current which flows through each component in case of operation of the output circuit 23. Therefore, further detailed description of the configuration of the circuit shown in FIG. 8 by is omitted.

The circuit diagram shown in FIG. 11 contains five arrows which show the first current I21 to the fifth current I25. Because the first current I21 to the fifth current I25 shown in FIG. 11 are same as the first current I11 to the fifth current I15 shown in FIG. 8, further detailed description of them is omitted.

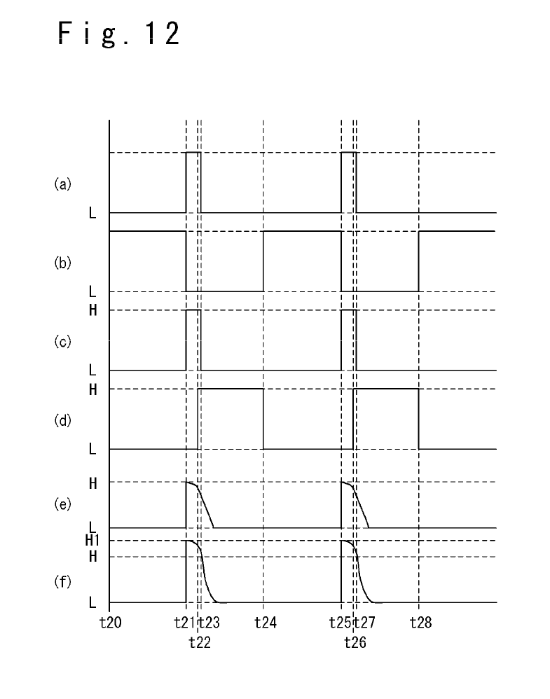

FIG. 12 is a time chart showing the time change of voltage at each node in the output circuit of the second embodiment in case of the extraordinary operation. Referring to FIG. 12, the operation when the extraordinary event due to the over-current has occurred in the output circuit 23 shown in FIG. 10 and FIG. 11 will be described in detail.

FIG. 12 contains six graphs of a first graph (a) to a sixth graph (f). The first graph (a) shows an example of the time change of voltage at the node which connects the node A shown in FIG. 11, i.e. one of the output nodes of the drive logic circuit section 30, the gate of the first output upper stage transistor 61A and the gate of the second output upper stage transistor 61B. The second graph (b) shows an example of the time change of voltage at the node which connects the node B shown in FIG. 11, i.e. the other output node of the drive logic circuit section 30, and the gate of the output lower stage transistor 62. The third graph (c) shows an example of the time change of voltage at the connection node of the node C shown in FIG. 11, i.e. the output terminal 10 (VOUT) and the load 9 outside the output circuit 23. The fourth graph (d) shows an example of the time change of voltage at the node which connects a node F shown in FIG. 11, i.e. the first voltage dividing resistance 53, the second voltage dividing resistance 54 and the gate of the second protection transistor 72. The fifth graph (e) shows an example of the time change of the fifth current I25 shown in FIG. 11. The sixth graph (f) shows an example of the time change of the third current I23 shown in FIG. 11.

In each of the first graph (a) to the sixth graphs (f) shown in FIG. 12, the horizontal axis shows time and the vertical axis shows voltage or current. Note that in each graph, “H” shows a high state and an on state and “L” shows a low state and an off state. However, these notations are for only convenience and these specific values may be different for every graph.

The initial state is shown at a time t20 in FIG. 12. Here, the voltage of the node A shown in the first graph (a) is in the low (L) state. The voltage of the node A shown in the second graph (b) is in the high (H) state. The voltage of the node C shown in the third graph (c) is in the low (L) state. The voltage of the node F shown in the fourth graph (d) is in the low (L) state. The fifth current I25 shown in the fifth graph (e) is in the off (L) state. The third current I23 shown in the sixth graph (f) is in the off (L) state.

At a time t21 shown in FIG. 12, the voltage of the node A rises up from the low (L) state to the high (H) state, and the voltage of the node B falls down from the high (H) state to the low (L) state. At this time, the first output upper stage transistor 61A and the second output upper stage transistor 61B are turned on, the output lower stage transistor 62 is turned off and the voltage of the node C rises up from the low (L) state to the high (H) state. As a result, the first current I21 and the second current I22 shown in FIG. 11 are generated. The fifth current I25 flows from the output terminal 10 (VOUT) to the ground 6 (GND) for a current shown in the fifth graph (e) of FIG. 12, even if the extraordinary event due to the over-current occurs at this time and a more excessive current than in the first embodiment tries to flow from the output terminal 10 (VOUT) to the load 9. As a result, the current which flows actually from the output terminal 10 (VOUT) to the load 9 is suppressed to a degree shown in the sixth graph (f) of FIG. 11. However, the third current I23 which flows through the load 9 is still excessive.

At a time t22 shown in FIG. 12, the voltage of the node F shown in the fourth graph (d) rises up from the low (L) state to the high (H) state, to thereby generate the second control signal. As a result, the second protection transistor 72 is turned on to connect the node A to the ground 6 (GND).

Immediately after, at a time t23 shown in FIG. 12, the voltage of the node A shown in the first graph (a) compulsorily falls down from the high (H) state to the low (L) state. As a result, because the first output upper stage transistor 61A and the second output upper stage transistor 61B are turned off compulsorily, the voltage of the node C shown in the third graph (c) compulsorily falls down from the high (H) state to the low (L) state. After that, the fifth current I25 shown in the fifth graph (e) and the third current I23 shown in the sixth graph (f) weaken rapidly and return to the off (L) state.

At a time t24 shown in FIG. 12, the voltage of the node A is kept to the low (L) state and does not change, and the voltage of the node B rises up from the low (L) state to the high (H) state. At this time, the first output upper stage transistor 61A and the second output upper stage transistor 61B are kept to the off state. The output lower stage transistor 62 is turned on and the voltage of the node C does not change and is kept to the low (L) state.

Because the following operation is same as that of the first embodiment, further detailed description is omitted.

As described above, according to the output circuit shown in FIG. 10 and FIG. 11, it is possible to compulsorily stop the supply of current to the load 9 at the time of turning-on even when the more excessive current than the operation of the output circuit in the first embodiment is generated. For example, when the extraordinary state has occurred to short-circuit the output terminal 10 (VOUT) and the ground 6 (GND), the current continues to flow through the load 9 as far as the output upper stage transistor group is in the on state, in addition to the time of turning-on. In such a case, according to the present embodiment, the first control transistor 51 and the second protection transistor 72 can operate to compulsorily stop the operation of the output upper stage transistor group.

Note that in the present embodiment, the operation of the protection function depends on the case of the extraordinary generation due to the over-heat and the case of the extraordinary generation due to the over-current.

### Third Embodiment

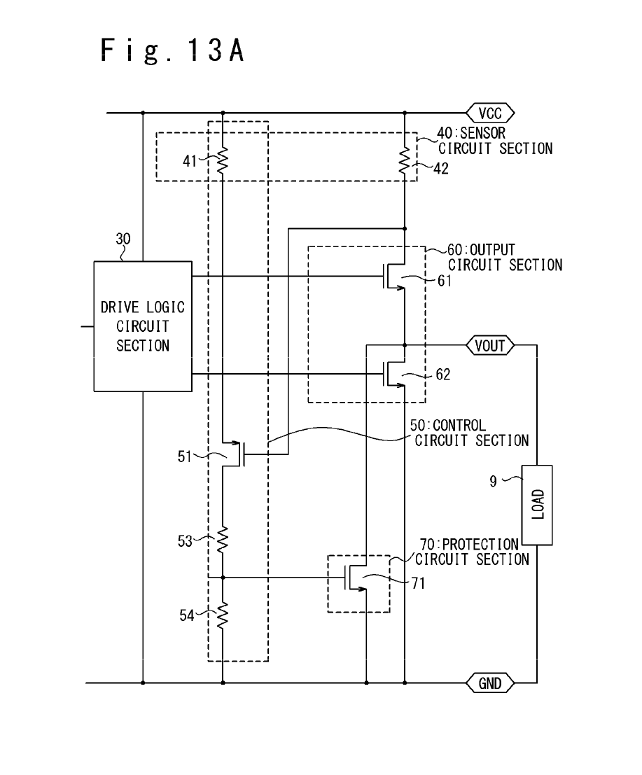

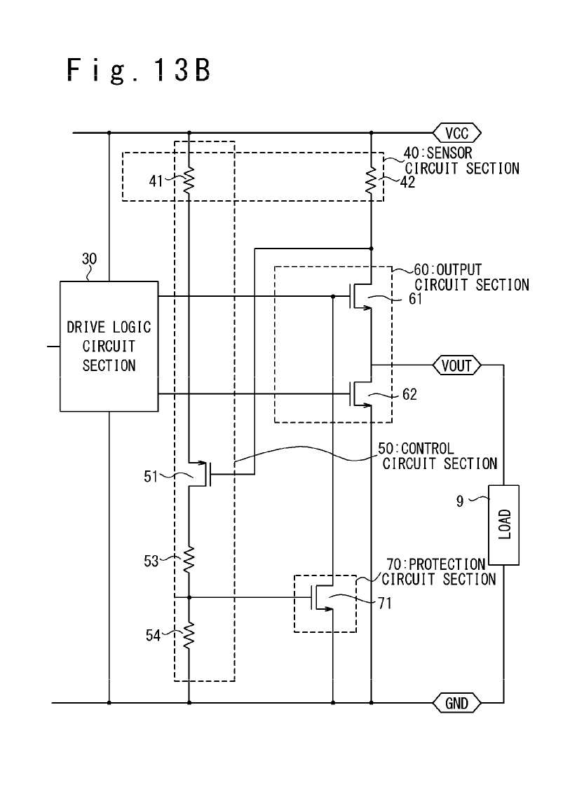

FIG. 13A is a circuit diagram showing the configuration of the output circuit according to a third embodiment.

The components of the output circuit shown in FIG. 13A will be described. The output circuit shown in FIG. 13A has the drive logic circuit section 30, the sensor circuit section 40, the control circuit section 50, the output circuit section 60, the protection circuit section 70 and the output terminal 10, like the output circuit shown in FIG. 6 and the output circuit shown in FIG. 10.

The components of the output circuit shown in FIG. 13A will be described in detail. The sensor circuit section 40 shown in FIG. 13A has the first sensor resistance 41 and the second sensor resistance 42. The control circuit section 50 shown in FIG. 13A has the control transistor 51, the first voltage dividing resistance 53 and the second voltage dividing resistance 54. The output circuit section 60 shown in FIG. 13A has the output upper stage transistor 61 and the output lower stage transistor 62. The protection circuit section 70 shown in FIG. 13A has the protection transistor 71.

Here, the control transistor 51 shown in FIG. 13A is a P-channel transistor. Also, the output upper stage transistor 61, the output lower stage transistor 62 and the protection transistor 71 which are shown in FIG. 13A are N-channel transistors.

In other words, by removing the first control transistor 51, the first voltage dividing resistance 53 and the first output upper stage transistor 61A from the output circuit shown in FIG. 6, and by changing the ability of the second output upper stage transistor 61B to be identical to the ability of the output lower stage transistor 62, the output circuit shown in FIG. 13A is obtained.

Note that it is supposed that in this case, the first sensor resistance 41 and the second sensor resistance 42 have a negative temperature coefficient and a positive temperature coefficient, respectively, like the case of the first embodiment. However, it is desirable that the resistance values of the first sensor resistance 41 and the second sensor resistance 42 are equal to each other at the time of the room temperature.

The connection relation of the drive logic circuit section 30, the sensor circuit section 40, the control circuit section 50, the output circuit section 60, the protection circuit section 70, the output terminal 10, the power supply 4 (VCC) and the ground 6 (GND) which are shown in FIG. 13A is same as in the case of the output circuit shown in FIG. 6 and the output circuit shown in FIG. 10. Therefore, further detailed description is omitted.

The connection relation of the components shown in FIG. 13A will be described in detail. The power supply 4 (VCC) is connected with one end of the drive logic circuit section 30 and the first sensor resistance 41 and one end of the second sensor resistance 42 in common. The other end of the first sensor resistance 41 is connected with the source of the first control transistor 51. The other end of the second sensor resistance 42 is connected with the gate of the first control transistor 51 and the drain of the output upper stage transistor 61 in common.

The drain of the first control transistor 51 is connected with one end of the first voltage dividing resistance 53. The other end of the first voltage dividing resistance 53 is connected with one end of the second voltage dividing resistance 54 and the gate of the protection transistor 71 in common.

One of the output nodes of the drive logic circuit section 30 is connected with the gate of the output upper stage transistor 61. The other output node of the drive logic circuit section 30 is connected with the gate of the output lower stage transistor 62. The source of the output upper stage transistor 61, the drain of the output lower stage transistor 62 and the drain of the protection transistor 71 are connected with the output terminal 10 (VOUT) in common. The drive logic circuit section 30, the other end of the second voltage dividing resistance 54, the source of the protection transistor 71 and the source of the output lower stage transistor 62 are connected with the ground 6 (GND) in common. The output terminal 10 (VOUT) is connected with the load 9 outside.

In other words, the power supply 4 (VCC), the second sensor resistance 42, the output upper stage transistor 61, the output terminal 10 (VOUT), the output lower stage transistor 62 and the ground 6 (GND) are connected in series in this order.

Also, the power supply 4 (VCC), the first sensor resistance 41, the control transistor 51, the first voltage dividing resistance 53, the second voltage dividing resistance 54 and the ground 6 (GND) are connected in series in this order.

The operation of the output circuit 23 shown in FIG. 13A will be described. First, because the operation of the drive logic circuit section 30 is same as that of the first embodiment, further detailed description is omitted.

Next, when one of signals of the signal pair which is outputted from a corresponding one of the outputs of the drive logic circuit section 30 is set to the high state, the output upper stage transistor 61 is turned on. When the output upper stage transistor 61 is turned on, the current flows through the second sensor resistance 42. This current flows from the power supply 4 (VCC) to the output terminal 10 (VOUT) through the second sensor resistance 42 and the output upper stage transistor 61 in this order. When the current flows through the second sensor resistance 42, the Joule heat is generated and the second sensor resistance 42 is heated. When the second sensor resistance 42 is heated, the resistance value changes according to this temperature change.

A condition equation when the control transistor 51 operates in the output circuit of the present embodiment is as follows:

VTH51<VGS51=I42×R42−I41×R41

Here, VTH51 and VGS51 show voltages of a threshold voltage and a voltage between the gate and source of the control transistor 51. I42 and R42 show a current value of current flowing through the second sensor resistance 42 and a resistance value of the resistance 42. I41 and R41 show a current value of current flowing through the first sensor resistance 41 and the resistance value of the resistance 41.

In the above-mentioned conditional equation, the current value of current I41 is constant and it is supposed that the current value of current I42 is larger for about 2 digits than the current value of I41. When the extraordinary event due to the over-heat has occurred, the resistance value of the second sensor resistance 42 becomes larger than that of the first sensor resistance 41, i.e. the following conditional equation is satisfied:

R42>R41

At this time, by selecting a parameter of each resistance in advance so that the voltage between the gate and the source exceeds the threshold voltage in the control transistor 51, the operation of the control transistor 51 becomes possible at the time of the occurrence of the extraordinary event due to the over-heat.

Also, when the extraordinary event due to the over-current has occurred, the current I42 increases while the current I41 keeps a constant value. Therefore, the control transistor 51 is possible to operate at the time of the extraordinary event due to a power-on operation.

When the extraordinary event due to the power-on or the over-heat has occurred in this way, the control transistor 51 operates. The following operation of the output circuit 23 according to the present embodiment is same as that of the first embodiment. That is, according to the operation of the control transistor 51, the control signal is outputted to the gate of the protection transistor 71 from the connection node of the first voltage dividing resistance 53 and the second voltage dividing resistance 54. The protection transistor 71 connects the output terminal 10 (VOUT) to the ground 6 (GND) in response to the control signal. As a result, it becomes possible to restrain a current at the time of turn-on by passing away a part of the current to be supplied to the output terminal 10 (VOUT) to the ground 6 (GND) in case of generation of the over-heat or the over-current.

According to the third embodiment described above, it is possible to detect the over-heat or the over-current with less components in order to protect the load 9, compared with the case of the first embodiment. However, the detection sensitivity of the over-heat is worse than the case of the first embodiment, because large current flows as the current I42, that is, the sensitivity depends on the temperature coefficient of the second sensor resistance.

Note that it is possible to compulsorily stop the operation of the output upper stage transistor 61 in case of occurrence of the extraordinary event, like the second embodiment, if the connection node of the drain of the protection transistor 71 is changed from the output terminal 10 (VOUT) in case shown in FIG. 13A to a connection node between the gate of the output upper stage transistor 61 and one of the outputs of the drive logic circuit section 30. FIG. 13B is a circuit diagram showing a different configuration of the output circuit of the third embodiment. However, in case of the different configuration, the operation of the output upper stage transistor 61 is compulsorily stopped even when an extraordinary event due to the over-heat occurs in addition to the extraordinary event due to the over-current, unlike the second embodiment.

### Fourth Embodiment

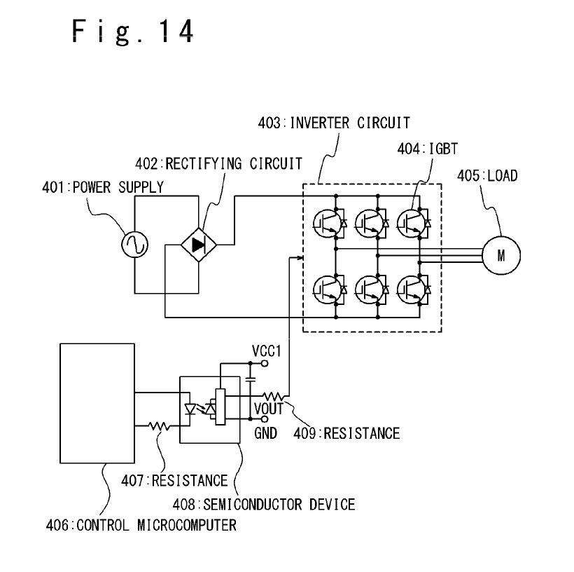

Next, a configuration example of the electronic apparatus using the semiconductor device according to the first to third embodiments will be described. FIG. 14 is a block circuit diagram showing a configuration example of an AC servo system according to a fourth embodiment.

The AC servo system shown in FIG. 14 has a power supply 401, a rectifying circuit 402, an inverter circuit 403, a load 405, a control microcomputer 406, a resistance 407, a semiconductor device 408 and a resistance 409. Note that although not shown, the AC servo system having the configuration example shown in FIG. 14 has six resistances 407, six semiconductor devices 408 and six resistances 409 actually.

The rectifying circuit 402 is connected with the power supply 401. The inverter circuit 403 is connected with the rectifying circuit 402. On the other hand, the six semiconductor devices 408 are connected with the control microcomputer 406 through the six resistances 407 connected in parallel. The inverter circuit 403 is connected with the six semiconductor devices 408 through the six resistances 409. The load 405 is connected with the inverter circuit 403.

Here, the power supply 401 is an AC power supply and outputs AC power. The rectifying circuit 402 has a plurality of diodes, and rectifies the AC power supplied from the power supply 401 to output DC power. Note that the rectifying circuit 402 may have a condenser to smooth the waveform of the DC power to be outputted. The inverter circuit 403 has six IGBTs (Insulated Gate Bipolar Transistor). These IGBTs are connected in series two by two and the series connections are connected in parallel. The inverter circuit outputs 3-phase AC power based on the DC power supplied from the rectifying circuit 402 and a control signal to be described later. The load 405 is a 3-phase motor and operates according to the 3-phase power supplied from the inverter circuit 403.

The control microcomputer 406 generates six control signals to control the six IGBTs contained in the inverter circuit 403, individually and in cooperation. The six semiconductor devices 408 receive the control signals from the control microcomputer 406 and transfers to the gates of six IGBTs. Further detailed description of the semiconductor devices 408 is omitted in this case, because it operates in the same way as the case of the first to third embodiments.

In this way, the semiconductor devices 408 are provided between the control microcomputer 406 and the gates of IGBTs to drive the IGBTs of the inverter circuit 403. By electrically insulating the control microcomputer 406 from the inverter circuit 403 by photo-couplers of the semiconductor devices 408, there is no risk that the noise in the inverter circuit 403 is superimposed on the side of the control microcomputer 40.

### Fifth Embodiment

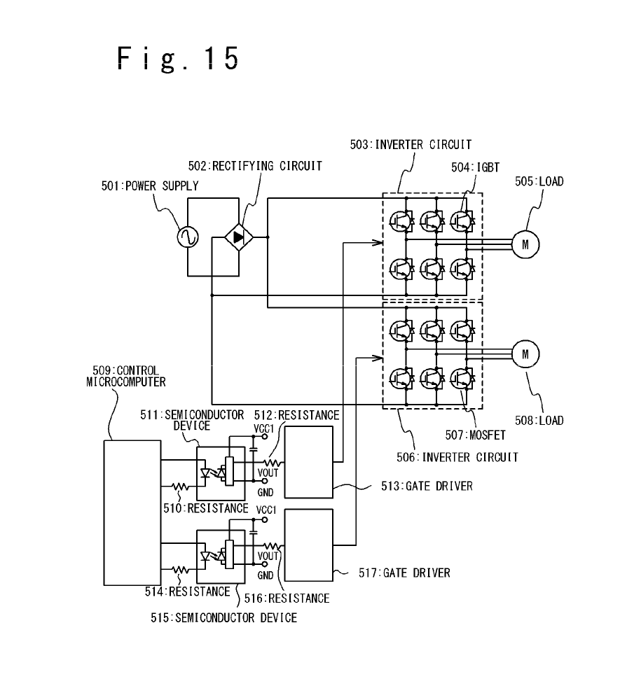

FIG. 15 is a block circuit diagram showing a configuration example of a compressor unit of an air conditioner in a fifth embodiment. The compressor unit of the air conditioner shown in FIG. 15 has a power supply 501, a rectifying circuit 502, a first inverter circuit 503, a first load 505, a second inverter circuit 506 and a second load 508. This compressor unit of the air conditioner further has a control microcomputer 509, a resistance 510, a first semiconductor device 511, a resistance 512, a first gate driver 513, a resistance 514, a second semiconductor device 515, a resistance 516 and a second gate driver 517. Note that although not shown, the compressor unit of the air conditioner in the configuration example shown in FIG. 15 has six resistances 510, six semiconductor devices 511, six resistances 512 and six gate drivers 513 actually. Also, the compressor unit of the air conditioner in the configuration example shown in FIG. 15 has six resistances 514, six semiconductor devices 515, six resistances 516 and six gate drivers 517.

The rectifying circuit 502 is connected with the power supply 501. The first inverter circuit 503 and the second inverter circuit 506 are connected with the rectifying circuit 502 in parallel.

On the other hand, the six semiconductor devices 511 are connected with the control microcomputer 509 respectively through six resistances 510. The six gate drivers 513 are connected with the six semiconductor devices 511 respectively through the six resistances 512. The gates of the six IGBTs 504 of the first inverter circuit 503 are connected with the six gate drivers 513.

Also, the six semiconductor devices 515 are connected with the control microcomputer 509 through the six resistances 514. The six gate drivers 517 are connected with the six semiconductor devices 515 through the six resistances 516. The gates of the six MOSFETs (Metal-Oxide-Semiconductor Field Effect Transistor) 507 of the second inverter circuit 506 has are connected with the six gate drivers 517.

The first load 505 is connected with the first inverter circuit 503 in the rear stage thereof. The second load 508 is connected with the second inverter circuit 506 in a rear stage thereof.

Here, the power supply 501 is an AC power supply and outputs AC power. The rectifying circuit 502 has a plurality of diodes, and rectifies the AC power supplied from the power supply 501 and outputs the DC power. Note that the rectifying circuit 502 may have a condenser to smooth the waveform of the DC power to be outputted.

The first inverter circuit 503 has the six IGBTs. These IGBTs are connected in series two by two and the series connections are connected in parallel and the 3-phase power is outputted based on the DC power supplied from the rectifying circuit 402 and a control signal to be described later. The first load 505 is a 3-phase motor of the compressor unit and operates in the 3-phase power supplied from the first inverter circuit 503.

The second inverter circuit 603 has the six MOSFETs. These MOSFETs are connected in series two by two and the series connections are connected in parallel. The 3-phase power is outputted based on the DC power supplied from the rectifying circuit 502 and a control signal to be described later. The second load 508 is a fan motor and operates in the 3-phase power supplied from the second inverter circuit 506.

The control microcomputer 509 generates six first control signals to control the six IGBTs contained in the first inverter circuit 503, individually and in cooperation, and generates six second control signals to control the six MOSFETs contained in the second inverter circuit 506 individually and in cooperation. The six semiconductor devices 511 receive the first control signals from the control microcomputer 509 to transfer to the gates of the six IGBTs through the six gate drivers 513. The six semiconductor devices 515 receive the second control signals from the control microcomputer 509 to transfer to the gates of the six MOSFETs through the six gate drivers 517. Further detailed description of the semiconductor devices 511 and 515 is omitted in this case, because it is same as that of the first-third embodiment.

In this way, the semiconductor devices 511 and 515 are provided between the control microcomputer 509 and first gate driver 513 and between the control microcomputer 509 and the second gate drivers 517 to drive the IGBTs of the first inverter circuit 503 and the MOSFETs of the second inverter circuit 506, like the case of the fourth embodiment. The control microcomputer 509 and the gate drivers 513 and 517 are electrically insulated by photo-couplers of the semiconductor devices 408.

Of course, a kind and polarity of each transistor which is contained in the output circuit 23 in the embodiments described above, a resistance value of each resistance and a value and polarity of a temperature coefficient, a voltage and polarity of a power supply and the ground and so on may be selected freely in the range where the output circuit 23 operates correctly, and may be combined.

As above, the present invention has been described based on embodiments. However, the present invention is not limited to the embodiments and various modifications are possible in a range not deviating from the concepts of the present invention. Also, the features described in the embodiments may be freely combined in a range without any technical contradict.

What is claimed is:

1. A semiconductor device comprising:
a photo-coupler configured to optically transfer an electric signal;
a drive logic circuit section connected with said photo-coupler and configured to generate a signal pair based on the transferred electric signal;
a sensor circuit section configured to receive a power supply voltage and output a temperature dependent voltage group which changes based on a temperature change;
an output circuit section configured to receive the temperature dependent voltage group, and output an output voltage obtained by amplifying the signal pair, from an output terminal;
a control circuit section configured to receive the power supply voltage and generate a control signal group based on the temperature dependent voltage group; and
a protection circuit section configured to stop the output of the output voltage from said output terminal based on the control signal group.

2. The semiconductor device according to claim 1, wherein said output circuit section comprises:
an output upper stage transistor group configured to receive the temperature dependent voltage group, amplify one signal of the signal pair to output to said output terminal; and
an output lower stage transistor group configured to receive a ground voltage and amplify the other signal of the signal pair to output to said output terminal,
wherein said sensor circuit section comprises a sensor resistances group in which a resistance value of at least one sensor resistance changes based on a temperature change of the sensor resistance,
wherein said control circuit section comprises:
a control transistor group in which at least one control transistor is switched between an operating state and a non-operating state based on the temperature dependent voltage group outputted from said sensor resistance group;
a voltage division circuit group configured to voltage-divide a control intermediate voltage group outputted from said control transistor group in the operating state to output as the control signal group; and
a voltage division node group from which the control signal group is outputted, and
wherein said protection circuit section comprises a protection transistor group configured to connect said output terminal to the ground voltage based on the control signal group.

3. The semiconductor device according to claim 2, wherein the temperature dependent voltage group comprises a first temperature dependent voltage and a second temperature dependent voltage, and
wherein said sensor resistance group comprises:
a first sensor resistance whose resistance value changes based on a first coefficient with the temperature change, and which is configured to receive the power supply voltage and output the first temperature dependent voltage; and
a second sensor resistance whose resistance value changes based on a second coefficient which is different from the first coefficient, with the temperature change, and which is configured to receive the power supply voltage and output the second temperature dependent voltage.

4. The semiconductor device according to claim 3, wherein the control intermediate voltage group comprises a control intermediate voltage,
wherein said control transistor group comprises a control transistor configured to receive the first temperature dependent voltage and output the control intermediate voltage,
wherein said voltage division circuit group voltage-divides the control intermediate voltage and comprises a first voltage division resistance and a second voltage division resistance,
wherein said voltage division node group comprises a voltage division node connected between said first voltage division resistance and said second voltage division resistance,
wherein said output upper stage transistor group comprises an output upper stage transistor whose gate is connected with a first output node of said drive logic circuit section which outputs the one signal of the signal pair,
wherein said output lower stage transistor group comprises an output lower stage transistor whose gate is connected with a second output node of said drive logic circuit section which outputs the other signal of the signal pair,
wherein said protection transistor group comprises a protection transistor whose source and drain are connected between said output terminal and the ground voltage and whose gate is connected with the voltage division node, and
wherein a gate of said control transistor is connected with a node between said second sensor resistance and said output upper stage transistor.

5. The semiconductor device according to claim 3, wherein said control transistor group comprises:
a first control transistor configured to receive the power supply voltage by one of a source and a drain thereof and receive the first temperature dependent voltage by a gate thereof; and
a second control transistor configured to receive the first temperature dependent voltage by one of a source and a drain thereof and receive the second temperature dependent voltage by a gate thereof,
wherein said voltage division node group comprises a voltage division node,
wherein said voltage division circuit group comprises:
a first voltage division resistance connected between the other of said source and said drain of said first control transistor and said voltage division node;
a second voltage division resistance connected said voltage division node and the ground voltage; and
a third voltage division resistance connected between the other of said source and said drain of said second control transistor and said voltage division node,
wherein said output upper stage transistor group comprises:
a first output upper stage transistor configured to have a gate thereof connected with a first output node of said drive logic circuit section which outputs the one signal of the signal pair, receive the first temperature dependent voltage by one of a source and a drain thereof, the other of said source and said drain thereof being connected with said output terminal; and
a second output upper stage transistor having a gate connected with said first output node of said drive logic circuit section and configured to receive the second temperature dependent voltage by one of a source and a drain thereof, the other of said source and said drain thereof being connected with said output terminal,
wherein said output lower stage transistor group comprises an output lower stage transistor having a gate connected with a second output node of said drive logic circuit section which outputs the other signal of the signal pair, and a source and a drain, which are connected between said output terminal and said ground voltage, and
wherein said protection transistor group comprises a protection transistor having a gate connected with said voltage division node and having a source and a drain, which are connected between said output terminal and said ground voltage.

6. The semiconductor device according to claim 3, wherein said control transistor group comprises:
a first control transistor configured to receive the power supply voltage by one of a source and a drain thereof and receive the first temperature dependent voltage by a gate thereof; and
a second control transistor configured to receive the first temperature dependent voltage by one of a source and a drain thereof and receive the second temperature dependent voltage by a gate thereof,
wherein said voltage division node group comprises a first voltage division node and a second voltage division node,
wherein said voltage division circuit group comprises:
a first voltage division resistance connected between the other of said source and said drain of said first control transistor and said first voltage division node;
a second voltage division resistance connected between said first voltage division node and the ground voltage;
a third voltage division resistance connected between the other of said source and said drain of said second control transistor and said second voltage division node; and
a fourth voltage division resistance connected between said second voltage division node and the ground voltage,
wherein said output upper stage transistor group comprises:
a first output upper stage transistor configured to have a gate connected with said first output node of said drive logic circuit section which outputs the one of the signals of the signal pair, and a source and a drain, and receive the first temperature dependent voltage by one of said source and said drain thereof, the other of said drain and said source thereof being connected with said output terminal; and
a second output upper stage transistor configured to have a gate connected with said first output node of said drive logic circuit section, and a source and a drain, and receive the second temperature dependent voltage by one of said sources and said drain thereof, the other of said source and said drain thereof being connected with said output terminal,
wherein said output lower stage transistor group comprises:
an output lower stage transistor configured to have a gate connected with the second output node of said drive logic circuit section which outputs the other signal of the signal pair, and a drain and a source connected between said output terminal and the ground voltage, and
wherein said protection transistor group comprises:
a first protection transistor configured to have a gate connected with said first voltage division node and have a drain and a source connected between the first output node of said drive logic circuit section and the ground voltage; and
a second protection transistor configured to have a gate connected with said second voltage division node and have a drain and a source connected between said output terminal and the ground voltage.

7. The semiconductor device according to claim 2, wherein said sensor resistance group comprises a polysilicon resistance.

8. The semiconductor device according to claims 2, wherein said sensor resistance group comprises a diffusion resistance.

9. An electronic apparatus comprising:
an inverter circuit configured to supply a power to a load;
a control microcomputer configured to generate an inverter control signal to control an operation of said inverter circuit; and
a plurality of semiconductor devices, each of which is configured to transfer the inverter control signal to said inverter circuit,
wherein said semiconductor device comprises:
a photo-coupler configured to optically transfer the inverter control signal;
a drive logic circuit section connected with said photo-coupler and configured to generate a signal pair based on the transferred inverter control signal;
a sensor circuit section configured to receive a power supply voltage and output a temperature dependent voltage group which changes based on a temperature change;
an output circuit section configured to receive the temperature dependent voltage group, and output an output voltage obtained by amplifying the signal pair, as a control output signal from an output terminal;
a control circuit section configured to receive the power supply voltage and generate a control signal group based on the temperature dependent voltage group; and
a protection circuit section configured to stop the output of the output voltage from said output terminal based on the control signal group.

10. The electronic apparatus according to claim 9, wherein said output circuit section comprises:
an output upper stage transistor group configured to receive the temperature dependent voltage group, amplify one signal of the signal pair to output to said output terminal; and
an output lower stage transistor group configured to receive a ground voltage and amplify the other signal of the signal pair to output to said output terminal,
wherein said sensor circuit section comprises a sensor resistances group in which a resistance value of at least one sensor resistance changes based on a temperature change of the sensor resistance,
wherein said control circuit section comprises:
a control transistor group in which at least one control transistor is switched between an operating state and a non-operating state based on the temperature dependent voltage group outputted from said sensor resistance group;
a voltage division circuit group configured to voltage-divide a control intermediate voltage group outputted from said control transistor group in the operating state to output as the control signal group; and
a voltage division node group from which the control signal group is outputted, and
wherein said protection circuit section comprises a protection transistor group configured to connect said output terminal to the ground voltage based on the control signal group.

11. The electronic apparatus according to claim 10, wherein the temperature dependent voltage group comprises a first temperature dependent voltage and a second temperature dependent voltage, and
wherein said sensor resistance group comprises:
a first sensor resistance whose resistance value changes based on a first coefficient with the temperature change, and which is configured to receive the power supply voltage and output the first temperature dependent voltage; and
a second sensor resistance whose resistance value changes based on a second coefficient which is different from the first coefficient, with the temperature change, and which is configured to receive the power supply voltage and output the second temperature dependent voltage.

12. The electronic apparatus according to claim 11, wherein the control intermediate voltage group comprises a control intermediate voltage,
wherein said control transistor group comprises a control transistor configured to receive the first temperature dependent voltage and output the control intermediate voltage,
wherein said voltage division circuit group voltage-divides the control intermediate voltage and comprises a first voltage division resistance and a second voltage division resistance,
wherein said voltage division node group comprises a voltage division node connected between said first voltage division resistance and said second voltage division resistance,
wherein said output upper stage transistor group comprises an output upper stage transistor whose gate is connected with a first output node of said drive logic circuit section which outputs the one signal of the signal pair,
wherein said output lower stage transistor group comprises an output lower stage transistor whose gate is connected with a second output node of said drive logic circuit section which outputs the other signal of the signal pair,
wherein said protection transistor group comprises a protection transistor whose source and drain are connected between said output terminal and the ground voltage and whose gate is connected with the voltage division node, and
wherein a gate of said control transistor is connected with a node between said second sensor resistance and said output upper stage transistor.

13. The electronic apparatus according to claim 11, wherein said control transistor group comprises:
a first control transistor configured to receive the power supply voltage by one of a source and a drain thereof and receive the first temperature dependent voltage by a gate thereof; and
a second control transistor configured to receive the first temperature dependent voltage by one of a source and a drain thereof and receive the second temperature dependent voltage by a gate thereof,
wherein said voltage division node group comprises a voltage division node,
wherein said voltage division circuit group comprises:
a first voltage division resistance connected between the other of said source and said drain of said first control transistor and said voltage division node;
a second voltage division resistance connected said voltage division node and the ground voltage; and
a third voltage division resistance connected between the other of said source and said drain of said second control transistor and said voltage division node,
wherein said output upper stage transistor group comprises:
a first output upper stage transistor configured to have a gate thereof connected with a first output node of said drive logic circuit section which outputs the one signal of the signal pair, receive the first temperature dependent voltage by one of a source and a drain thereof, the other of said source and said drain thereof being connected with said output terminal; and
a second output upper stage transistor having a gate connected with said first output node of said drive logic circuit section and configured to receive the second temperature dependent voltage by one of a source and a drain thereof, the other of said source and said drain thereof being connected with said output terminal,
wherein said output lower stage transistor group comprises an output lower stage transistor having a gate connected with a second output node of said drive logic circuit section which outputs the other signal of the signal pair, and a source and a drain, which are connected between said output terminal and said ground voltage, and
wherein said protection transistor group comprises a protection transistor having a gate connected with said voltage division node and having a source and a drain, which are connected between said output terminal and said ground voltage.

14. The electronic apparatus according to claim 11, wherein said control transistor group comprises:
a first control transistor configured to receive the power supply voltage by one of a source and a drain thereof and receive the first temperature dependent voltage by a gate thereof; and
a second control transistor configured to receive the first temperature dependent voltage by one of a source and a drain thereof and receive the second temperature dependent voltage by a gate thereof,
wherein said voltage division node group comprises a first voltage division node and a second voltage division node,
wherein said voltage division circuit group comprises:
a first voltage division resistance connected between the other of said source and said drain of said first control transistor and said first voltage division node;
a second voltage division resistance connected between said first voltage division node and the ground voltage;
a third voltage division resistance connected between the other of said source and said drain of said second control transistor and said second voltage division node; and
a fourth voltage division resistance connected between said second voltage division node and the ground voltage,
wherein said output upper stage transistor group comprises:
a first output upper stage transistor configured to have a gate connected with said first output node of said drive logic circuit section which outputs the one of the signals of the signal pair, and a source and a drain, and receive the first temperature dependent voltage by one of said source and said drain thereof, the other of said drain and said source thereof being connected with said output terminal; and
a second output upper stage transistor configured to have a gate connected with said first output node of said drive logic circuit section, and a source and a drain, and receive the second temperature dependent voltage by one of said sources and said drain thereof, the other of said source and said drain thereof being connected with said output terminal,
wherein said output lower stage transistor group comprises:
an output lower stage transistor configured to have a gate connected with the second output node of said drive logic circuit section which outputs the other signal of the signal pair, and a drain and a source connected between said output terminal and the ground voltage, and
wherein said protection transistor group comprises:
a first protection transistor configured to have a gate connected with said first voltage division node and have a drain and a source connected between the first output node of said drive logic circuit section and the ground voltage; and
a second protection transistor configured to have a gate connected with said second voltage division node and have a drain and a source connected between said output terminal and the ground voltage.

15. The electronic apparatus according to claim 10, wherein said sensor resistance group comprises a polysilicon resistance.

16. The electronic apparatus according to claim 10, wherein said sensor resistance group comprises a diffusion resistance.

17. The electronic apparatus according to claim 10, further comprising:
a rectifying circuit configured to rectify AC power to supply DC power to said inverter circuit.

18. The electronic apparatus according to claim 10, wherein said inverter circuit comprises a plurality of IGBTs (Insulated Gate Bipolar Transistor), and
wherein said electronic apparatus further comprises a plurality of gate drivers configured to transfer the control output signals from said plurality of semiconductor devices to gates of said plurality of IGBTs, respectively.

19. The electronic apparatus according to claim 10, wherein said inverter circuit comprises a plurality of MOSFETs (Metal Oxide Semiconductor Field Effect Transistors), and
wherein said electronic apparatus further comprises a plurality of gate drivers configured to transfer the control output signals of said plurality of semiconductor devices to gates of said plurality of MOSFETs, respectively.
